(19) United States
(12) Patent Application Publication
(10) Pub. No.: US 2008/0035068 A1
(43) Pub. Date: Feb. 14, 2008

(54) Solar hummingbird fountain

(76) Inventor: Jun Gou, XinHua Town (CN)

Correspondence Address: SHAWN HUNTER, P.O Box 270110, HOUSTON, TX, 77277-0110, US

(21) Appl. No.: 11/502,889

(22) Filed: Aug. 12, 2006

(51) Int. Cl. A01K 7/00

(52) U.S. Cl. 119/72

(57) ABSTRACT

A solar bird fountain is provided with illumination directed to the fluid reservoir of the fountain to provide level indication in low light element as well as a pleasing reflection.

### BACKGROUND

1. Field of the Invention

The present invention relates generally bird fountains and in particular to a solar lit bird fountain.

2. Description of Related Art

Within the birding industry, and in particular within the hummingbird fountain market, a great variety of designs have been developed over the years. In particular, many designs have been developed for the various fluid containers and distribution systems for hummingbird fountains.

Concurrently, there has been a development of solar bird feeders in the related bird feeder market. For the last few years these solar bird feeders have proliferated but have remained a niche market among grain based bird feeders. Hummingbird aficionados have not been served by the development of solar bird feeders that are limited to serving only grains.

One problem not found in grain feeders is the issue of determining when a refill is needed from a distance, particularly in low light situations. Unlike grain, the fluid in hummingbird fountains is often clear and it can be difficult to discern the fluid level from a distance, particularly in low light conditions, such as after dusk and before dawn.

A need exists, therefore, for hummingbird fountain that uses solar technology to light the fountain in a decorative and useful manner while taking advantage of the unique designs available to hummingbird fountains that are not found in grain feeders.

All references cited herein are incorporated by reference to the maximum extent allowable by law. To the extent a reference may not be fully incorporated herein, it is incorporated by reference for background purposes and indicative of the knowledge of one of ordinary skill in the art.

### BRIEF SUMMARY OF THE INVENTION

The problems presented in the hummingbird fountain art are solved by the systems of the present invention. In accordance with one embodiment of the present invention, a solar humming bird feeder is provided.

Other objects, features, and advantages of the present invention will become apparent with reference to the drawings and detailed description that follow.

### BRIEF DESCRIPTION OF THE DRAWINGS

FIG. 1 is an embodiment of a hummingbird fountain having a fluid reservoir suspended below a canopy;

FIG. 2 is an embodiment of a hummingbird fountain positioned on a stake;

FIG. 3A is an embodiment of a hummingbird fountain having an enclosed fluid reservoir suspended below a canopy;

FIG. 3B is a sectional view of the embodiment of FIG. 3A;

FIG. 4 is an embodiment of a hummingbird fountain having an enclosed fluid reservoir suspended below a canopy and with drinking tubes extending below the reservoir.

### DETAILED DESCRIPTION OF THE PREFERRED EMBODIMENT

In the following detailed description of the preferred embodiments, reference is made to the accompanying drawings, which form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical mechanical and electrical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

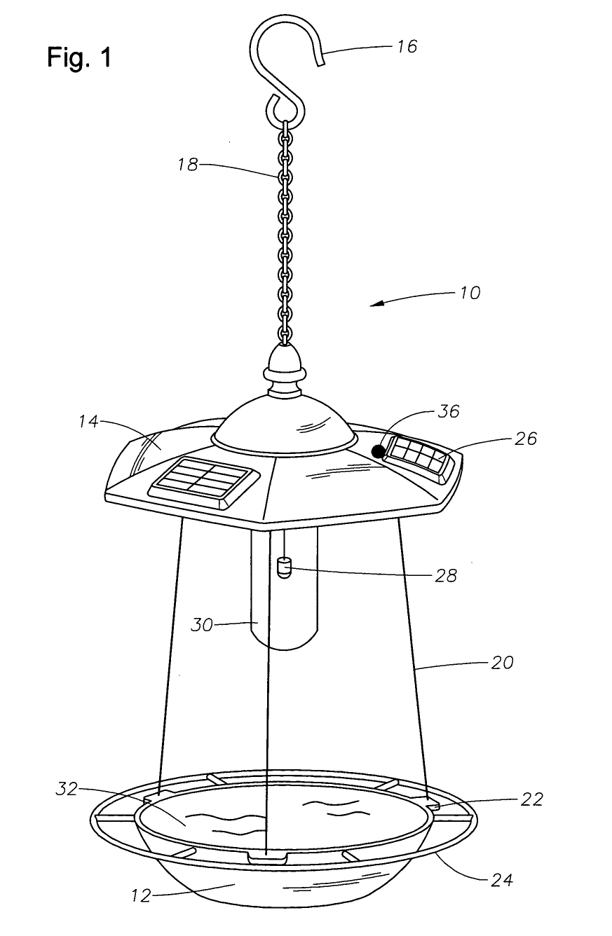

FIG. 1 is an embodiment of a hummingbird fountain 10 having a fluid reservoir 12 suspended below a canopy 14. Fountain 10 is supported by a hanger 16 attached to canopy 14 by a canopy chain 18. Reservoir 12 is supported by reservoir wires 20 attached to canopy 14 and extending down to support tabs 22 on the periphery of reservoir 12. Also positioned on the periphery of reservoir 12 is perch 24.

Canopy 14 houses solar panels 26 on an upper side to collect solar energy and convert solar energy into electrical energy. Light element 28 is suspended from a lower side of canopy 14 and housed within a diffuser 30. Light element 28 is positioned to add decorative lighting by illuminating any fluid 32 in fluid reservoir 12. Light element 28 may be an LED, cold cathode, incandescent light, or any similar lighting technology. LED's currently provide a good balance of lighting efficiency and cost, but other technologies may be developed to operate as a light element. Diffuser 30 directs illumination into fluid 32 to increase the decorative effect of light element 28 and add fluid movement to light element that is reflected or refracted within fluid 32, much like the lighting applied to a swimming pool at night. To increase this effect reservoir 12 may be transparent, translucent, or reflective, depending on the desired light element pattern. Even a non-reflective, non-translucent reservoir 12 will provide some of the desired reflection. A further advantage of light element 28 is the illumination of fluid 32 in reservoir 12 so that the level of fluid 32 may be determined from a distance in low light element conditions more readily.

Canopy 14 also includes recharge able power source 34 (not shown), which stores electrical energy from solar panels 26 during daylight element hours, and photo resistor 36, which controls the flow of electrical energy into batteries 34 during daylight element hours and from batteries 34 into light element 28 during low light element times, as is well understood in the solar lighting art. Recharge able power source 34 may be a standard metal acid recharge able battery or may be a more complex system, such as a fuel cell, for example. Currently nickel cadmium and nickel metal hydroxide batteries provide the best balance of cost and performance for this application, but lithium ion batteries and other batteries will likely be useful as recharge able power source 34 in the near future as pricing and technology change.

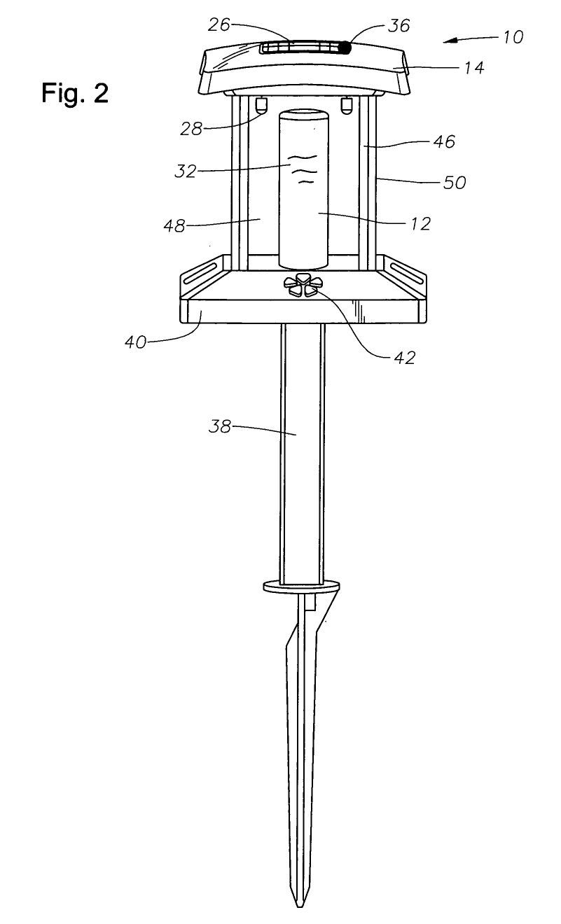

FIG. 2 is an embodiment of a hummingbird fountain 10 positioned on a stake 38. Fountain 10 comprises a drinking base 40 that sits atop stake 38. Base 40 includes drinking stations 42. Base 40 supports a fluid reservoir 12 to provide fluid to drinking stations 42. Canopy 14 is attached to base 40 by cover supports 46. Canopy 14 is positioned above reservoir 12. Canopy 14 houses a solar panel 26, recharge able power source 34 (not shown), photo resistor 36 and at least one light element 28. Light element 28 is positioned to illuminate any fluid 32 in reservoir 12. Additionally, enclosure 48 is positioned to enclose light element 28 and reservoir 12. Enclosure 48 provides an additional refraction surface while also protecting reservoir 12 and light element 28 from the weather conditions. Enclosure 48 may be comprised of separate panels 50 extending between cover supports 46 or enclosure 48 may enclose supports 46.

Where enclosure 48 is essentially transparent light element 28 will assist in determining the level of fluid 32 in reservoir 12 from a distance in low light element conditions.

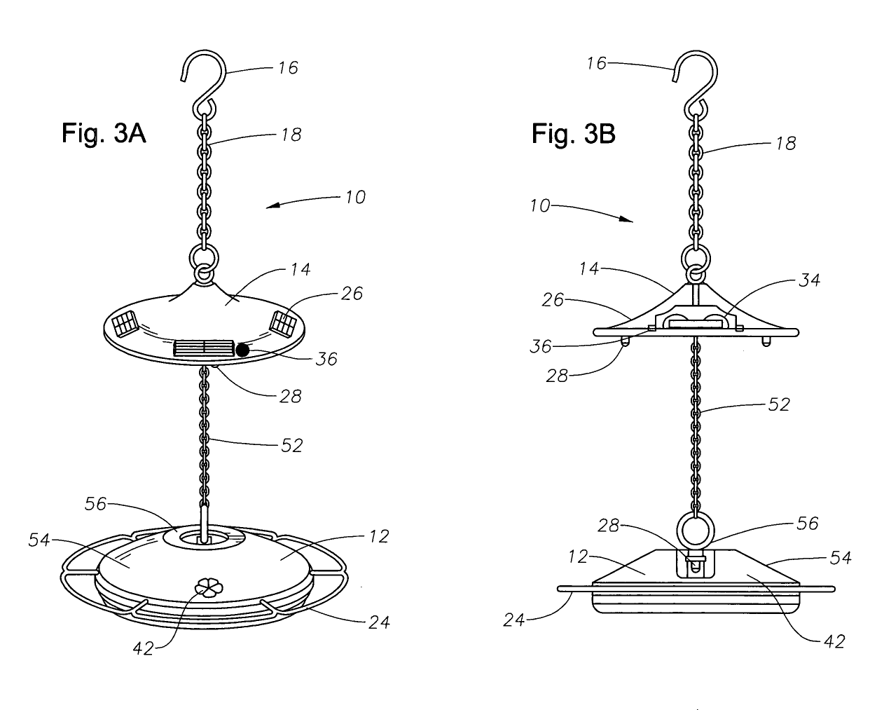

FIG. 3A is an embodiment of a hummingbird fountain 10 having an enclosed fluid reservoir 12 suspended below a canopy 14. Fountain 10 is supported by hanger 16 which is attached to canopy 14 by canopy chain 18. Reservoir 12 is suspended below canopy 14 by reservoir chain 52. Reservoir 12 has a top surface 54 that encloses fluid 32 and supports drinking stations 42. Reservoir 12 may also have a perch 24.

Canopy 14 has solar panels 26 on an upper surface and light element 28 on a lower surface such that light element 28 illuminates reservoir 12, and particularly top surface 54 and drinking stations 42.

FIG. 3B is a sectional view of the embodiment of FIG. 3A and therefore shows one way of packaging recharge able power source 34, panels 26, photo resistor 36, and light element 28 in a canopy 14.

Also shown in FIG. 3B is a light element 28 being placed within reservoir 12 to illuminate reservoir 12 and fluid 32 in a decorative fashion. In particular, reservoir chain 52 is attached to reservoir plug 56, which attaches securely with tops surface 54. To increase the effect of light element 28 being placed within reservoir 12, reservoir plug 56 and top surface 54 may be made of translucent or even transparent materials. A functional aspect of this design is that it allows for easy confirmation of the level of fluid 32 in reservoir 12 in low light element conditions from a distance. Furthermore, fluid 32 will distort the illumination from light element 28 in a pleasing way.

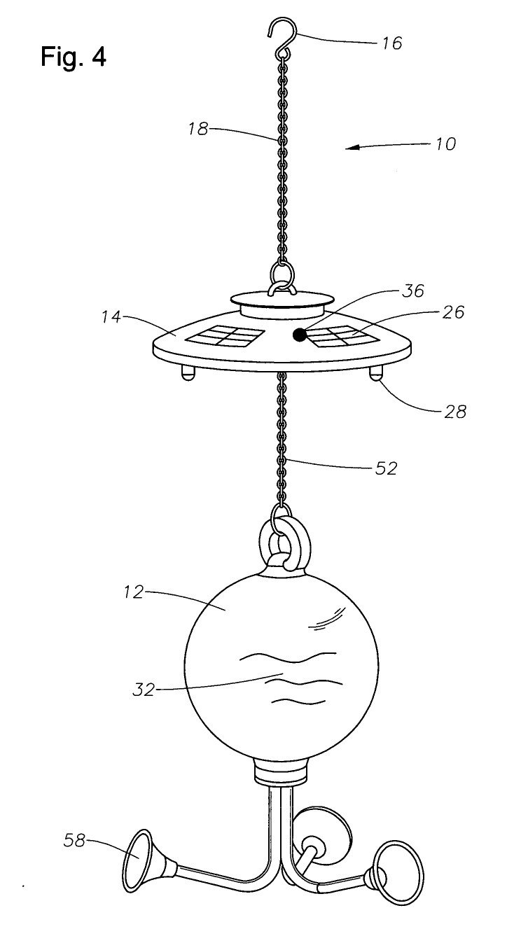

FIG. 4 is an embodiment of a hummingbird fountain 10 having an enclosed fluid reservoir 12 suspended below a canopy 14 and with drinking tubes 58 extending below the reservoir 12. Similar to previous embodiments, canopy 14 includes panels 26, recharge able power source 34 (not shown), photo resistor 36, and light element 28. Photo resistor 36 controls the flow of electrical energy such that during daylight element hours panels 26 convert light element into electrical energy that may be stored in recharge able power source 36. Then, during low light element conditions the electrical energy stored in recharge able power source 36 may be directed to power light element 28.

Enclosed fluid reservoir 12 is suspended below canopy 14 by reservoir chain 52. Reservoir 12 may be translucent or transparent to allow fluid 32 to reflect illumination from light element 28 and allow for easier determination of the level of fluid 32 in reservoir 12 in low light element conditions.

In each of the preceding examples fluid 32 may be any fluid suitable for consumption by birds, such as water, water mixed with a sugar, water mixed with honey, water sweetened by another sweetener, water mixed with a coloring agent, water mixed with a sweetener and a coloring agent, or other similar liquids appropriate for consumption by birds, and specifically humming birds.

The primary advantage of the present invention is the provision of safe, inexpensive, useful and decorative lighting for a hummingbird fountain for use in gardens and other similar environments. This lighting provides a decorative reflection off of the fluid 32 in fountain 10 while also providing an aid in determining the level of fluid 32 in reservoir 12.

It should be apparent from the foregoing that an invention having significant advantages has been provided. While the invention is shown in only a few of its forms, it is not just limited but is susceptible to various changes and modifications without departing from the spirit thereof.

I claim:

1. A bird fountain comprising:
a fluid reservoir for containing a fluid suitable to be consumed by birds;
a canopy positioned above the reservoir, the canopy having a solar panel for converting daylight element into electrical energy, a recharge able power source for storing electrical energy, and a light element illuminated by electrical energy;
wherein the light element illuminates the fluid reservoir.

2. The bird fountain according to claim 1 wherein the fluid reservoir is translucent such that illumination from the light element is reflected by any fluid in the fluid reservoir.

3. The bird fountain according to claim 1 wherein the fluid reservoir is transparent such that illumination from the light element is reflected by any fluid in the fluid reservoir.

4. The bird fountain according to claim 1 further comprising a photo resistor conducively coupled to the recharge able power source for activating and deactivating the recharge able electrical power source depending upon the amount of light element hitting the photo resistor, which automatically control the light element to turn on at dusk and off at dawn.

5. The bird fountain according to claim 1 further comprising a diffuser covering the light element.

6. The bird fountain according to claim 1 further comprising a hanger connected to the canopy by a canopy chain.

7. The bird fountain according to claim 1 further comprising a drinking station in fluid communication with the fluid reservoir.

8. The bird fountain according to claim 1 further comprising a stake supporting fluid the fluid reservoir.

9. A bird fountain comprising:
a hanger having a canopy chain attached;
a canopy attached to a lower end of the canopy chain, the canopy housing a solar panel, photo resistor, and a light element,
reservoir wires attached to the canopy,
a fluid reservoir attached to a lower end of the reservoir wires and thereby suspended below the canopy such that the light element illuminates the fluid reservoir.

10. The bird fountain according to claim 9 further comprising fluid in the fluid reservoir such that when the light element illuminates the fluid reservoir the fluid is illuminated as well and the level of the fluid may be discerned in low light element conditions.

11. The bird fountain according to claim 9 wherein the fluid reservoir is transparent.

12. The bird fountain according to claim 9 wherein the fluid reservoir is translucent.

13. A bird fountain comprising:
a canopy having a solar panel, and a recharge able power source;
an enclosed fluid reservoir suspended below the canopy, the fluid reservoir having a top surface and plug securely fitted to the top surface;
wherein a light element is positioned within the plug and in electrical communication with the recharge able power source such that the light element illuminates the fluid reservoir.

14. The bird fountain according to claim 13 further comprising additional light elements on the canopy for further illumination of the fluid reservoir.

15. The bird fountain according to claim 13 further comprising additional lights on the fluid reservoir for further illumination of the bird fountain.

16. The bird fountain according to claim 13 wherein the enclosed reservoir further comprises drinking stations positioned on the top surface.

17. The bird fountain of claim 13 further comprising a photo resistor in electrical communication with the recharge able power source.
